(19) United States
(12) Patent Application Publication
(10) Pub. No.: US 2021/0078090 A1
(43) Pub. Date: Mar. 18, 2021

(54) METHOD FOR GRINDING A BEVEL GEAR

(71) Applicant: Klingelnberg GmbH, Huckeswagen (DE)

(72) Inventors: Karl-Martin Ribbeck, Remscheid (DE); Rolf Schalaster, Wermelskirchen (DE)

(21) Appl. No.: 17/018,270

(22) Filed: Sep. 11, 2020

(30) Foreign Application Priority Data
Sep. 13, 2019 (DE) 102019124696.2

(51) Int. Cl. B23F 9/02

(52) U.S. Cl. CPC B23F 9/025

(57) ABSTRACT

Method for grinding a bevel gear, comprising the method steps of clamping a bevel gear (14) to be ground on a workpiece spindle (12) of a bevel gear grinding machine (2); first grinding of the tooth flanks (16, 18) of the bevel gear (14) with a first grinding tool (6), wherein the first grinding tool (6) is arranged on a first tool spindle (4) of the bevel gear grinding machine (2); fine grinding of the tooth flanks (16, 18) of the bevel gear (14) with a second grinding tool (10), wherein the second grinding tool (10) is arranged on a second tool spindle (8) of the bevel gear grinding machine (2).

### CROSS-REFERENCE TO RELATED APPLICATIONS

This application claims the benefit under 35 U.S.C. § 119(e) to German patent application no. DE10 2019 124 696.2 filed Sep. 13, 2019, which is hereby expressly incorporated by reference as part of the present disclosure.

### FIELD OF THE INVENTION

The present invention relates to a method for grinding a bevel gear.

### BACKGROUND

Bevel gear teeth are usually pre-toothed, hardened and finally fine-machined. The fine machining can be carried out by grinding and/or lapping.

Depending on the size of the component and the required machining quality, a bevel gear can be ground in one, two or more passes or cycles. A grinding tool can be dressed as required.

For example, a bevel gear on a single machine tool can be ground with two cycles in one clamping and with one grinding tool. In order to achieve a particularly high surface quality, it may be provided that the grinding tool is dressed before each individual cycle. In this case, the grinding tool is first dressed for a first grinding operation in order to optimally adjust the grinding tool with regard to its geometry and/or sharpness for the first grinding operation in the first cycle. The grinding tool is then dressed again for a second grinding operation in order to optimally adjust the geometry and/or sharpness of the grinding tool for the second grinding operation in the second cycle. In this case, after finishing the grinding operation on the bevel gear workpiece concerned, the grinding tool is dressed again for a first machining operation on another bevel gear workpiece. For the application described above, it may therefore be envisaged that two dressing operations will be required for each bevel gear to be ground, which means high wear of the grinding tool and increased time expenditure.

Alternatively, the two cycles described above can be carried out by a grinding operation with a first grinding tool on a first grinding machine and a subsequent, further grinding operation with a second grinding tool on a second grinding machine. The two cycles are therefore carried out on separate grinding machines. Between the grinding processes, the bevel gear workpiece to be ground must be reclamped from the first to the second grinding machine. This reclamping is time-consuming and leads to a reduced machining accuracy compared to machining in one and the same clamping.

Against this background, the invention is based on the technical problem of specifying a method for grinding bevel gears which does not have the above disadvantages or at least to a lesser extent and which, for example, allows a more efficient production of high surface qualities.

The technical problem described above is solved by a method according to claim 1. Further embodiments of the invention result from the dependent claims and the description below.

The invention relates to a method for grinding a bevel gear, comprising the following method steps: clamping a bevel gear to be ground on a workpiece spindle of a bevel gear grinding machine; first grinding of the tooth flanks of the bevel gear with a first grinding tool, wherein the first grinding tool is arranged on a first tool spindle of the bevel gear grinding machine; fine grinding of the tooth flanks of the bevel gear with a second grinding tool, wherein the second grinding tool is arranged on a second tool spindle of the bevel gear grinding machine.

The use of a bevel gear grinding machine with two tool spindles, each carrying one grinding tool, has the advantage that the first grinding and the fine grinding can be carried out with two separate tools, while the bevel gear can remain on the work spindle in the same clamping. Thus, the grinding operation is characterized by high efficiency and accuracy, as there is no need for reclamping and, in addition, machining can be carried out with two separate grinding tools. By machining in one clamping, the grinding allowance remaining before fine grinding can be reduced.

If in the present case reference is made to a grinding tool, it can be a grinding wheel or a cup grinding wheel for bevel gear grinding.

If in the present case reference is made to grinding of the tooth flanks, this means in particular complete machining of the active tooth flanks, i.e. all areas of the respective tooth flanks from the tooth tip to the tooth root that roll in tooth contact with a bevel gear pair with a counter flank.

It may be provided that in addition to the tooth flank, the tooth root and/or the tooth space bottom and/or the tooth tip of a tooth of a respective tooth flank may also be ground.

If in the present case it is mentioned that the tooth flanks are machined with the first grinding tool and with the second grinding tool, this means that all tooth flanks which are machined with the first grinding tool are also machined with the second grinding tool, in particular they are also machined completely with the second grinding tool.

For example, it may be provided that all tooth flanks to be ground are first machined with the first grinding tool and then all tooth flanks to be ground are machined with the second grinding tool. Alternatively, it may be provided that the tooth flanks are first machined with the first and then with the second grinding tool before the next tooth flank is machined with the first and then with the second grinding tool.

It may be provided that during the first grinding, first all convex flanks and then all concave flanks are ground with the first grinding tool. Alternatively, it may be provided that a concave and a convex flank are ground alternately with the first grinding tool.

It may be provided that during fine grinding, first all convex flanks and then all concave flanks are ground with the second grinding tool. Alternatively, it may be provided that a concave and a convex flank are ground alternately with the second grinding tool.

According to one embodiment of the method it may be provided that after the first grinding and before fine grinding a dressing of the second grinding tool is carried out, wherein a dressed grinding tool topography is generated for fine grinding.

In order to further increase the machining accuracy, it may be provided that after the first grinding and before fine grinding, a second grinding of the tooth flanks of the bevel gear is carried out with the first grinding tool. The first grinding can be referred to as rough grinding, the second grinding as finish grinding and the fine grinding as polishing grinding.

It may be provided that the first grinding tool is dressed after the first grinding and before the second grinding, creating a dressed grinding tool topography for the second grinding. The grinding tool is therefore optimized for the second grinding and adapted, for example, with regard to its geometry and/or sharpness.

If in the present case it is mentioned that the sharpness of a grinding tool is adjusted, this means, for example, that the grinding tool for the first grinding has a higher stock removal rate compared to the second grinding, i.e. is sharper or has a higher roughness. In contrast, the grinding tool for the second grinding has a lower stock removal rate than the first grinding and is therefore less sharp or has a lower roughness.

According to one embodiment of the method it is provided that the first grinding tool is dressed before the first grinding, wherein a dressed grinding tool topography is generated for the first grinding and wherein the dressed grinding tool topography for the first grinding differs from the dressed grinding tool topography for the second grinding.

It may be provided that dressing prior to the first grinding is performed at a higher or lower relative speed between a dressing tool and the grinding tool compared to dressing prior to the second grinding. In particular, dressing prior to first grinding may be performed at a higher dressing factor than dressing prior to second grinding, wherein the dressing factor is defined as the peripheral speed of the dressing tool divided by the peripheral speed of the grinding tool. A higher dressing factor leads to a higher roughness of the dressed grinding tool and thus to a sharper grinding tool.

According to a further embodiment of the method, dressing prior to the first grinding may involve an eccentric motion between the dressing tool and the grinding tool, while dressing after the first and prior to the second grinding may involve no eccentric motion or a further eccentric motion different from the eccentric motion.

Alternatively, dressing after the first grinding and before the second grinding may involve an eccentric movement between the dressing tool and the grinding tool, while dressing before the first grinding involves no eccentric movement or a further eccentric movement different from the eccentric movement.

It may be provided that the grinding tool is dressed sharper for the first or second grinding operation while maintaining the same profile shape, so that between the first and second grinding only the surface condition of the grinding wheel is changed.

It may be provided that a speed of the grinding tool during the first grinding operation of the tooth flanks is higher or lower than a speed of the grinding tool during the grinding operation of the same tooth flanks during the second grinding operation. In particular, it may be provided that a speed of the grinding tool during the first grinding operation of the tooth flanks is higher than a speed of the grinding tool during the grinding operation of the same tooth flanks during the second grinding operation in order to avoid grinding scorch.

It may be provided that a speed of the grinding tool during the first grinding operation of the tooth flanks is identical to a speed of the grinding tool during the second grinding operation of the same tooth flanks.

In accordance with a further embodiment of the method, it is provided that the second grinding will be carried out with the same process parameters as those provided for the first grinding. The grinding tool may have been dressed before the second grinding.

According to an alternative embodiment, the second grinding can be carried out with process parameters that differ from those of the first grinding. The grinding tool may have been dressed before the second grinding.

It may be provided that the first and second grinding are carried out with identical grinding wheel parameters, in particular without prior dressing of the grinding wheel. It may be provided that the process parameters of the second grinding are different from or identical to those of the first grinding. For example, the second grinding can be carried out at a higher rotational or rolling speed. It may be provided that the first and second grinding are carried out with the same grinding wheel and process parameters, e.g. to compensate for surface waviness after hardening.

It may be provided that before the first grinding, an allowance for the nominal geometry to be produced, selected from a range of 0.07 mm up to and including 0.14 mm, is given for each tooth flank. In other words, an allowance of at least 0.07 mm up to a maximum of 0.14 mm per tooth flank to be ground can be reserved for the first grinding.

It may be provided that before the second grinding, an allowance for the nominal geometry to be produced, selected from a range of 0.02 mm up to and including 0.03 mm, is provided for each tooth flank. In other words, an allowance of at least 0.02 mm to a maximum of 0.03 mm per tooth flank to be ground can be reserved for the second grinding.

It may be provided that before fine grinding, an allowance for the nominal geometry to be produced, selected from a range of 0.01 mm up to and including 0.02 mm, is given for each tooth flank. In other words, an allowance of at least 0.01 mm to a maximum of 0.02 mm per tooth flank to be ground can be reserved for fine grinding. As a result of grinding the tooth flanks in one clamping, the required allowance before fine grinding can be reduced compared to processes that require reclamping.

According to one design of the method, it is provided that the tooth flanks after fine grinding have a surface roughness Ra that is 1.6 μm or less, in particular, 0.7 μm or less.

For example, it may be provided that the tooth flanks after fine grinding will have a surface roughness Ra selected from a range of Ra=0.01 μm to 1.6 μm. In particular, it may be provided that the tooth flanks after fine grinding have a surface roughness Ra selected from a range of Ra=0.01 μm to 0.7 μm.

For example, it may be provided that the tooth flanks after fine grinding will have a surface roughness Ra selected from a range of Ra=0.1 μm to 1.6 μm. In particular, it may be provided that the tooth flanks after fine grinding have a surface roughness Ra selected from a range of Ra=0.1 μm to 0.7 μm.

It may be provided that the grinding operation with the first grinding tool is a completing or a semi-completing operation, wherein both the convex and concave flanks are machined with the first grinding tool, and the grinding operation with the second grinding tool is a completing or semi-completing operation, wherein both the convex and the concave flanks are machined with the second grinding tool.

This means that both the convex and concave flanks are machined with the same grinding tool geometry of the first grinding tool, without the need to dress the first grinding tool alternating between machining from a concave to a convex flank, or vice versa.

Similarly, the grinding tool geometry of the second grinding tool can be used to machine both the convex and concave flanks of the bevel gear without the need to dress the second grinding tool alternating between machining from a concave to a convex flank, or vice versa.

The first abrasive tool may have a first abrasive grain and the second abrasive tool may have a second abrasive grain, wherein the second abrasive grain differs from the first abrasive grain in terms of grain size and/or grain material. Accordingly, it may be provided that the second abrasive tool has a finer grain size than the first abrasive tool, for example. For example, it may be provided that a grain size of the first abrasive grain is 80 and a grain size of the second abrasive grain is 180.

### BRIEF DESCRIPTION OF THE DRAWINGS

In the following, the invention is described in more detail on the basis of a drawing illustrating embodiment examples, which schematically show in each case:

FIG. 1 shows a machine tool with two tool spindles;

FIG. 2A shows a bevel gear in a perspective view;

FIG. 2B shows an enlarged section of the bevel gear from FIG. 2A;

FIG. 3 shows a flow chart of the method according to the invention.

### DETAILED DESCRIPTION

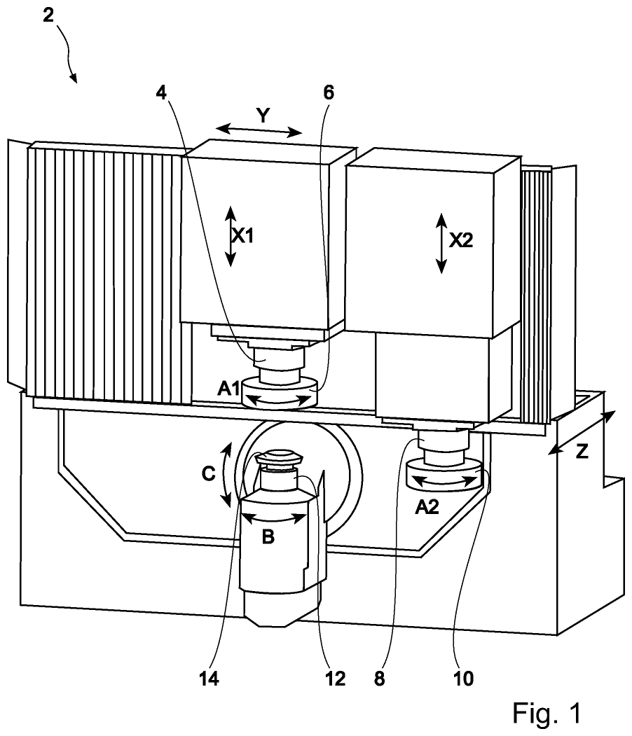

FIG. 1 shows a double spindle machine 2, which is a bevel gear grinding machine 2. The double spindle machine 2 has a first tool spindle 4 and a first grinding tool 6 is held on the first tool spindle 4. The double spindle machine 2 has a second tool spindle 8. A second grinding tool 10 is held on the second tool spindle 8.

The first tool spindle 4 is set up to drive the first grinding tool 6 (rotational axis Al). The first tool spindle 4 is displaceable in a translatory manner along the X1, Y and Z axes.

The second tool spindle 8 is set up to drive the second grinding tool 10 (rotational axis A2). The second tool spindle 8 is displaceable in a translatory manner along the X2, Y and Z axes.

A pre-toothed and hardened bevel gear 14 or bevel gear workpiece 14 is held on a workpiece spindle 12 of the double spindle machine 2. The terms bevel gear and bevel gear workpiece are used synonymously.

The workpiece spindle 12 can be pivoted (swivel axis C). The bevel gear 14 can rotate around its longitudinal axis by means of workpiece spindle 12 (rotational axis B).

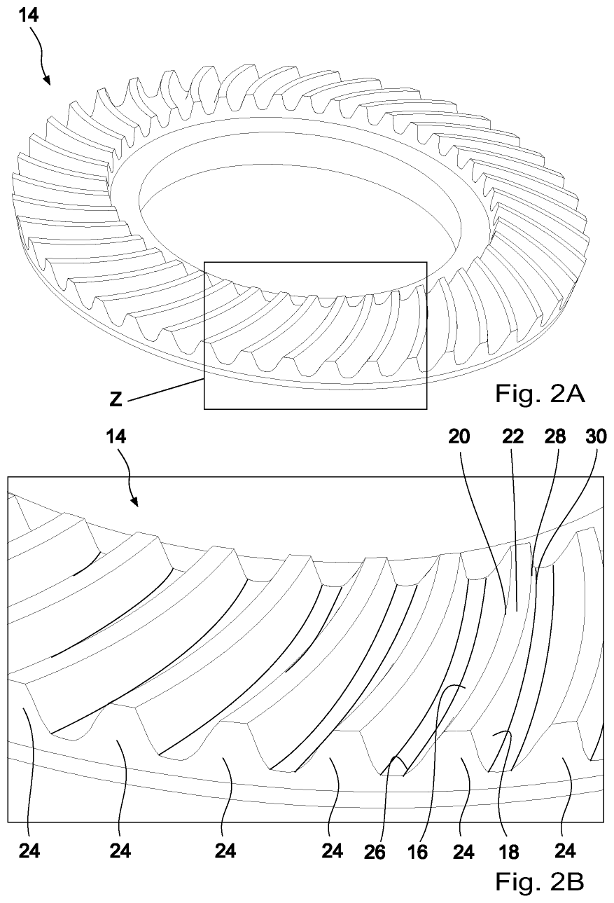

The bevel gear 14 has concave flanks 16 and convex flanks 18 (FIG. 2A, FIG. 2B). A respective concave flank 16 extends from a tip edge 20 of a tooth tip 22 of a tooth 24 of the bevel gear 14 to a tooth root 26 of the tooth 24, and a respective convex flank 18 extends from a tip edge 28 of the tooth tip 22 of the tooth 24 to a tooth root 30.

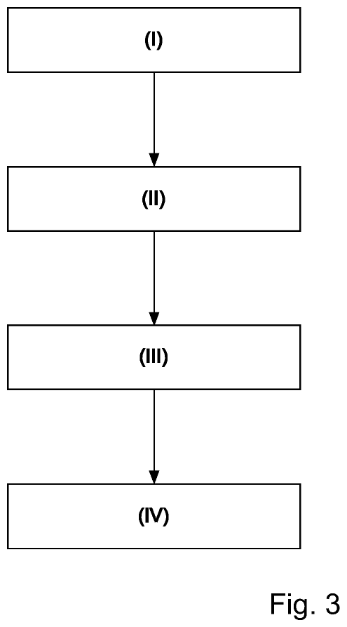

FIG. 3 shows a flowchart of a method according to the invention.

In a first method step (I), the pre-toothed and hardened bevel gear 14 is first clamped on the workpiece spindle 12 of the bevel gear grinding machine 2.

In a second method step (II) a first grinding of the tooth flanks 16, 18 of the bevel gear 14 is carried out with the first grinding tool 6, which is arranged on the first tool spindle 4. Before the first grinding, the grinding allowance for the nominal geometry to be produced is 0.100 mm per tooth flank. After the first grinding and before the second grinding, the grinding allowance for the nominal geometry to be produced is 0.025 mm per tooth flank.

In a further method step (III), after the first grinding and before a fine grinding, a second grinding of the tooth flanks 16, 18 of the bevel gear 14 is carried out, whereby the first grinding tool 6 is first dressed after the first grinding and before the second grinding, wherein a dressed grinding tool topography is generated for the second grinding.

The first grinding tool 6 has also been dressed before the first grinding, wherein a dressed grinding tool topography is generated for the first grinding.

The dressed grinding tool topography for the first grinding is different from the dressed grinding tool topography for the second grinding. These differing grinding tool topographies can be produced by a differing relative speed of the grinding tool relative to a dressing tool during dressing and/or by different kinematics during dressing, such as eccentric motion or the like.

After the second grinding, the fine grinding of the tooth flanks 16, 18 of the bevel gear 14 with the second grinding tool 10, which is held on the second tool spindle 8 of the bevel gear grinding machine 2, takes place in a further method step (IV).

Since the bevel gear grinding machine 2 has two separate grinding tools 6, 10 on separate tool spindles 4, 8, the bevel gear 14 can remain on the workpiece spindle 12 in one and the same clamping and can be machined alternately or first with the first grinding tool 6 and then with the second grinding tool 10.

After the second grinding and before fine grinding, there is an allowance of 0.015 mm per tooth flank for the nominal geometry to be produced. After fine grinding, the tooth flanks have a surface roughness Ra=0.7 μm.

The grinding operation with the first grinding tool 6 can be carried out as a completing or semi-completing process, wherein both the convex and concave flanks 16, 18 of the bevel gear 14 are completely machined with the first grinding tool 6, without having to dress the grinding tool 6 for a change from the concave to the convex flank or vice versa. The grinding tool 6 in its form dressed for the first grinding is therefore suitable for machining both the concave flanks 16 and the convex flanks 18.

Similarly, the first grinding tool 6, with its shape dressed for the second grinding, is suitable for machining both the convex flanks 18 and the concave flanks 16. Grinding tool 6 therefore does not have to be dressed in a flank-specific manner.

Furthermore, the second grinding tool 10 is also set up to machine the tooth flanks 16, 18 in the completing or semi-completing process, so that the second grinding tool 10 is also set up for the complete machining of both the convex flanks 18 and the concave flanks 16 without the need for flank-specific dressing when changing from the concave to the convex flank or vice versa.

The grinding tool 6 in this case is a cup grinding wheel 6 for machining bevel gears. The grinding tool 10 is in this case a cup grinding wheel for machining bevel gears.

The first grinding tool 6 has a first abrasive grain and the second grinding tool 10 has a second abrasive grain, wherein the second abrasive grain differs from the first abrasive grain in its grain size and/or grain material.

It may be provided that a respective tooth root 26, 30 of a respective tooth 24 of the bevel gear 14 is also ground.

It may be provided that a respective tooth tip 22 of a respective tooth 24 of the bevel gear 14 is also ground.

What is claimed is:

1. A method for grinding a bevel gear comprising:
clamping a bevel gear workpiece to be ground on a workpiece spindle of a bevel gear grinding machine;
performing a first grinding of tooth flanks of the bevel gear with a first grinding tool located on a first tool spindle of the bevel gear grinding machine; and
performing a fine grinding of the tooth flanks of the bevel gear with a second grinding tool located on a second tool spindle of the bevel gear grinding machine.

2. A method according to claim 1, further including
(i) after performing the first grinding and before performing the fine grinding, performing a second grinding of the tooth flanks of the bevel gear; and/or
(ii) after performing the first grinding and before performing the fine grinding, dressing the second grinding tool and generating thereby a dressed grinding tool topography of the second grinding tool adapted for said fine grinding.

3. A method according to claim 2, further including dressing the first grinding tool after performing the first grinding and before performing the second grinding and generating thereby a dressed grinding tool topography of the first grinding tool adapted for said second grinding.

4. A method according to claim 3, further including dressing the first grinding tool before performing the first grinding and generating thereby a dressed grinding tool topography of the first grinding tool adapted for said first grinding, wherein the dressed grinding tool topography adapted for said first grinding is different from the dressed grinding tool topography adapted for said second grinding.

5. A method according to claim 4, including performing the step of dressing the first tool before performing the first grinding at a higher or lower relative speed between a dressing tool and the first grinding tool compared to the during the step of dressing the first dressing tool after performing the first grinding and before performing the second grinding.

6. A method according to claim 4, wherein
the step of dressing the first grinding tool before performing the first grinding comprises an eccentric movement between a dressing tool and the first grinding tool, and the step of dressing the first grinding tool after performing the first grinding and before performing the second grinding either (a) does not include eccentric movement or (b) includes a second eccentric movement different from the eccentric movement, or
the step of dressing the first grinding tool after performing the first grinding and before performing the second grinding comprises an eccentric movement between a dressing tool and the first grinding tool, and the step of dressing the first grinding tool before performing the first grinding either (a) does not include eccentric movement or (b) includes a second eccentric movement different from the eccentric movement.

7. A method according claim 2, wherein the first and second grindings are performed with same or different process parameters.

8. A method according to claim 1, wherein
(i) before said fine grinding, each of said tooth flanks defines an allowance for a nominal geometry thereof to be produced of about 0.01 mm up to and including about 0.02 mm; and/or
(ii) after said fine grinding, said tooth flanks define a surface roughness Ra of about 1.6 μm or less.

9. A method according to claim 8, wherein said surface roughness Ra is about 0.7 μm or less.

10. A method according to claim 1, wherein
the step of performing the first grinding defines a completing or a semi-completing process and includes grinding convex and concave flanks of the tooth flanks; and
the step of performing the fine grinding defines a completing or a semi-completing process and includes grinding convex and concave flanks of the tooth flanks.

11. A method according to claim 1, wherein the first grinding tool includes a first abrasive grain and the second grinding tool includes a second abrasive grain that differs from the first abrasive grain by grain size and/or grain material.

12. A method according to claim 7, wherein the process parameters are the rotational speed or the rolling speed.
